(19) United States
(12) Patent Application Publication
(10) Pub. No.: US 2016/0360787 A1
(43) Pub. Date: Dec. 15, 2016

(54) Super Capacitor Vaping Electronic Cigarette With Integrated Power Pack

(71) Applicant: William Christopher Bailey, Springfield, OH (US)

(72) Inventor: William Christopher Bailey, Springfield, OH (US)

(21) Appl. No.: 14/739,037

(22) Filed: Jun. 15, 2015

(51) Int. Cl. A24F 47/00; H02J 7/00

(52) U.S. Cl. CPC A24F 47/008; H02J 7/0042; H02J 7/0052; H02J 2007/0062; H02J 7/345

(57) ABSTRACT

A super capacitor vaping electronic cigarette includes improvements in power recharging capabilities.

### TECHNICAL FIELD

The invention relates to the field of electronic cigarette products, in particular to a super capacitor vaping electronic cigarette with an integrated power pack.

### BACKGROUND

The prior electronic cigarettes typically employ a battery operatively connected to a heating element for heating the material which forms smoke. More particularly, the heating element generates heat causing the material in the electronic cigarette chamber to transition into smoke. The material can be a flavored gel or liquid and after placed into the heating element it is energized causing it to smoke.

This provides the user simulation of smoking. The chamber or atomizer atomizes the material (liquid smoke) as a result of voltage of the power supply (battery) directly loaded onto the electronic control switches on the heating element. The battery power is proportional to the amount of smoke the electronic cigarette produces. As the voltage decreases with time the amount of smoke electronic cigarette decreases.

Batteries are currently employed in most electronic cigarettes but have limits to their life. Pulse Width Modulation (PWM) have been employed to rapidly cycle high voltage and zero volts, turning the coil on and off very quickly to produce a set wattage. This is what causes the “rattlesnake” sound in some devices. Many people claim PWM produces a poor vaping experience and thus have not employed them.

It is often desired to have large coils in electronic cigarettes but this requires a high amp drain battery (e.g. 35 amp battery) to vape adequately which is expensive. Low drain batteries do not work well on large coil vape systems.

There is a need to decrease charging time, provide an on-demand power-supply with improved battery life and optionally removing the use of a battery in lieu of another power source.

### SUMMARY OF THE INVENTION

It is an object to enhance utility of electronic cigarettes.

It is another object to provide a rapid recharging of an electronic cigarette.

Another object is increase the rate of smoke generated with a given power supply.

A further object is decrease time for charging electronic cigarettes.

Another object is to improve battery life in electronic cigarettes.

Yet another object it to provide a secondary on-demand power supply to avoid delay in recharging.

Accordingly, the instant invention is directed to a super capacitor vaping electronic cigarette. In one embodiment, the invention includes charging port, such as a USB charging port, operatively connected to a battery and one or more capacitor (e.g., super capacitor in series) and also operatively connects to one or more diode (in series). The one or more diode operatively connects to a resistor which in turn connects to the one or more capacitors.

Additionally, there is provided a controller chip (processor) which has a charge terminal, a power terminal, a control connection to a coil of the vaping chamber of the electronic cigarette. There can also be provided a display unit operatively connected to controller chip.

In an alternative embodiment, there can be provided a Pulse Width Modulation (PWM) controller operatively interposed between the battery and the one or more capacitor. In lieu of a control chip, a digital current control board can be provided which chip is attached to a display screen that gives a readout of battery life, resistance, voltage and wattage as well as a vaporizer element.

In both embodiments, the invention is contained by a housing which contain the components in an operable manner to easily access the USB port, display, and chamber for receiving vape material without disassembling the housing.

The controller or digital current control board d is electrically connected to the between the power (super capacitor/battery) and the heating coil. A switch or button operably connected to the housing and the chip is capable of sending a signal to initiate the heating power of the heating coil.

The invention has of enabling a higher blast of vapor and taste and quickly recharge the device. A better understanding will be readily apparent from reading detail description and viewing the drawings hereinafter.

### BRIEF DESCRIPTION OF DRAWINGS

FIG. 1 is a schematic diagram of an embodiment of the invention; and

FIG. 2 is another schematic diagram of an embodiment of the invention.

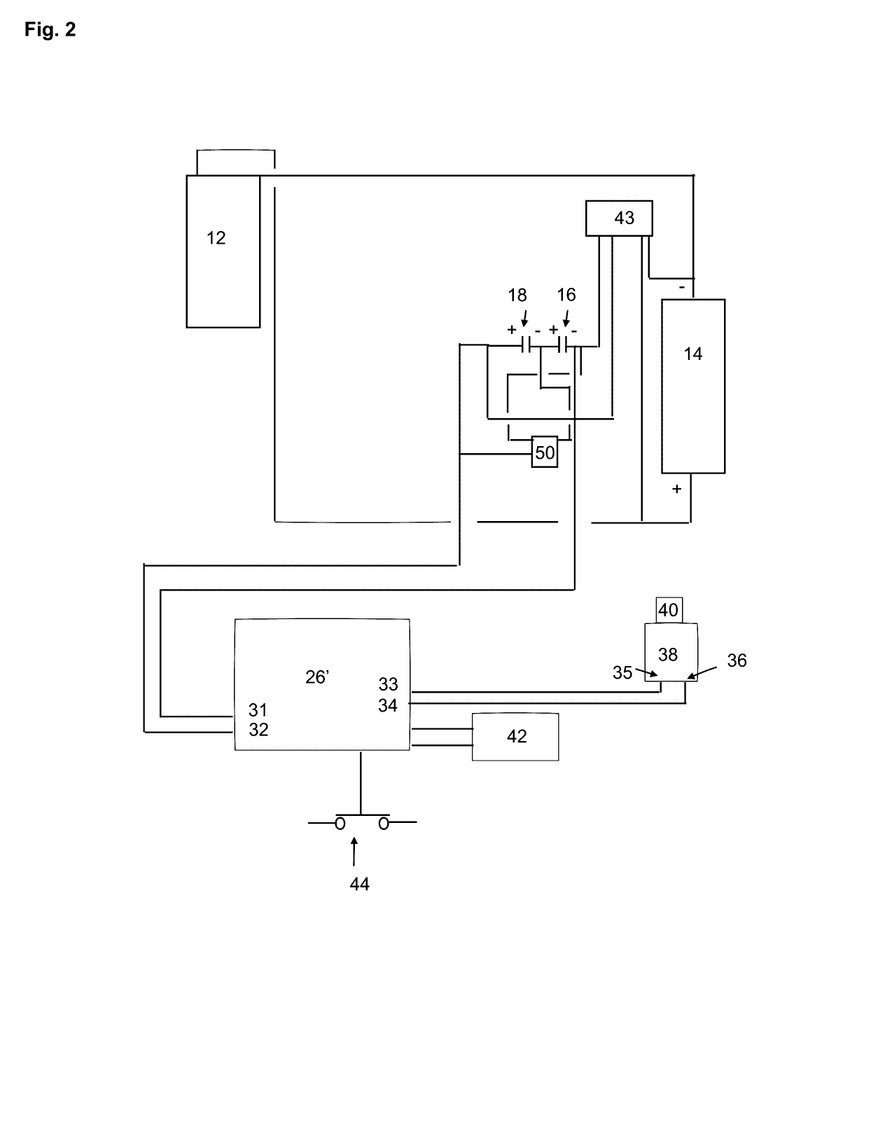

FIG. 3 is an embodiment of the invention of FIG. 1.

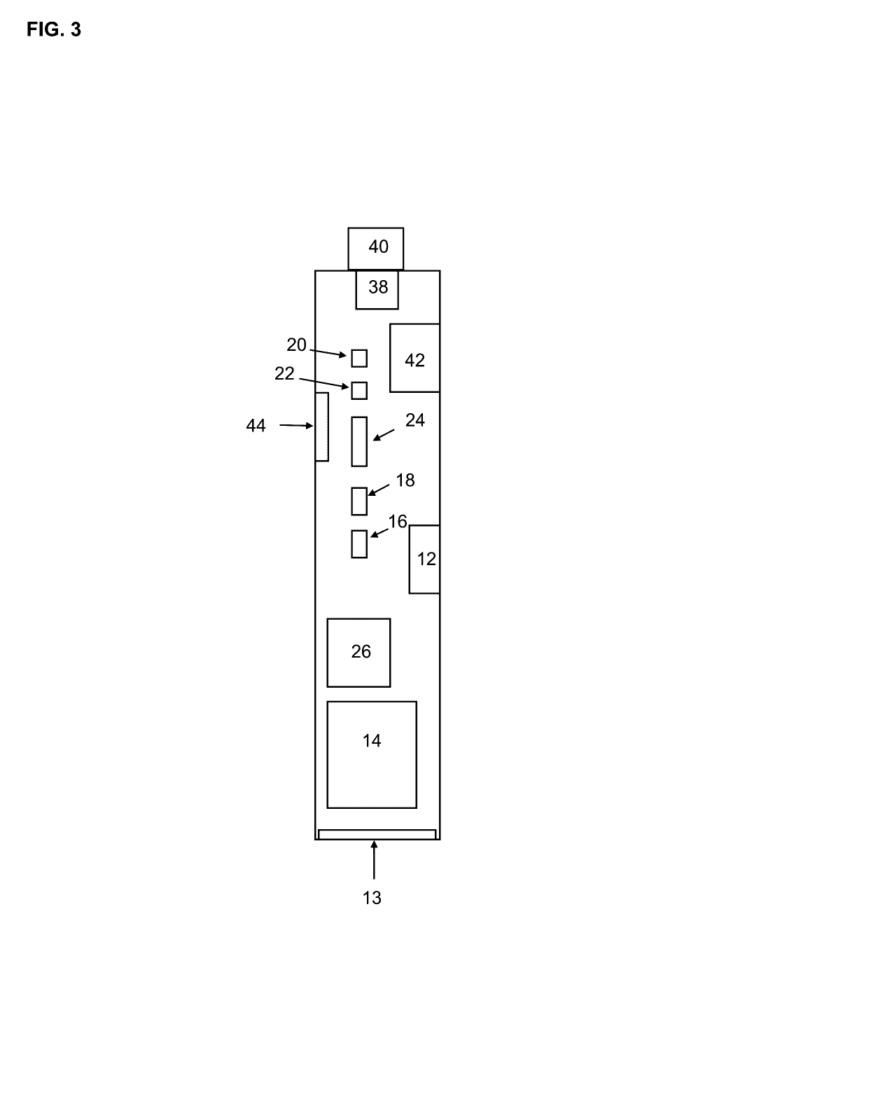

FIG. 4 is an embodiment of the invention of FIG. 2.

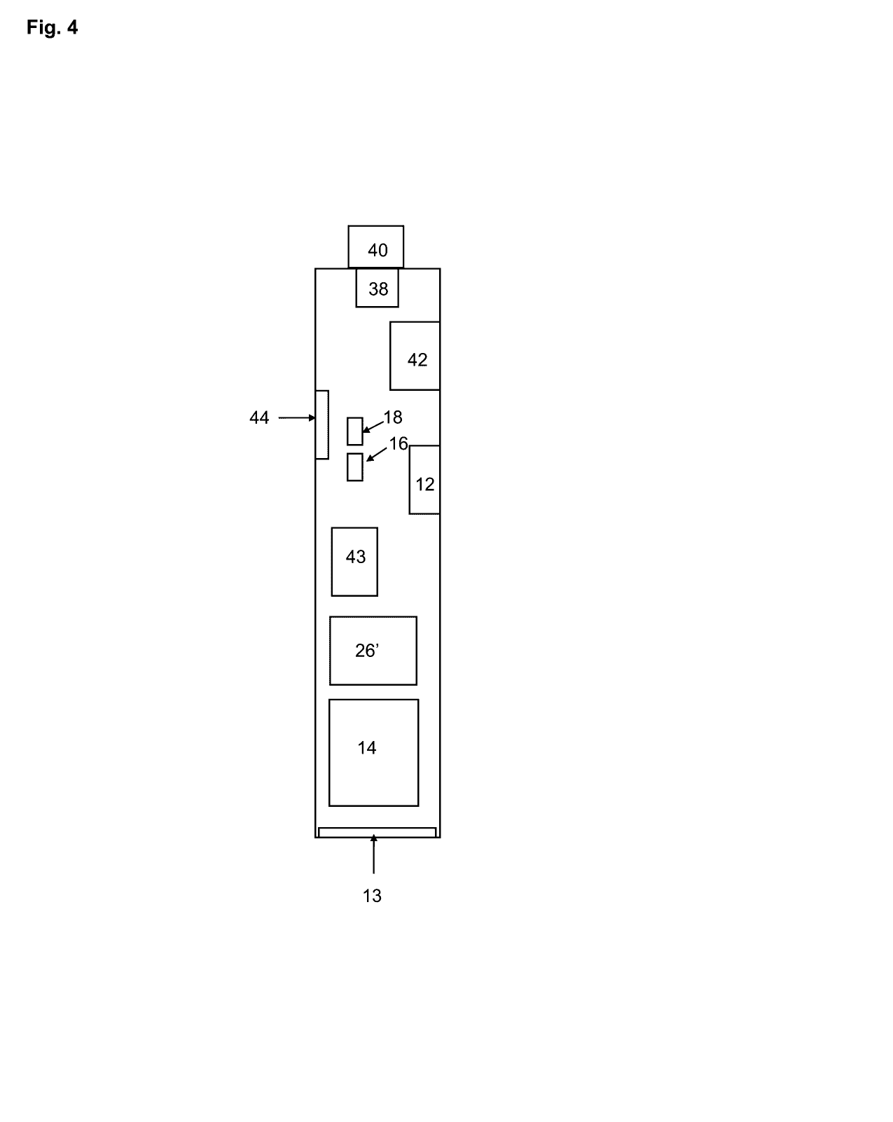

### DETAILED DESCRIPTION

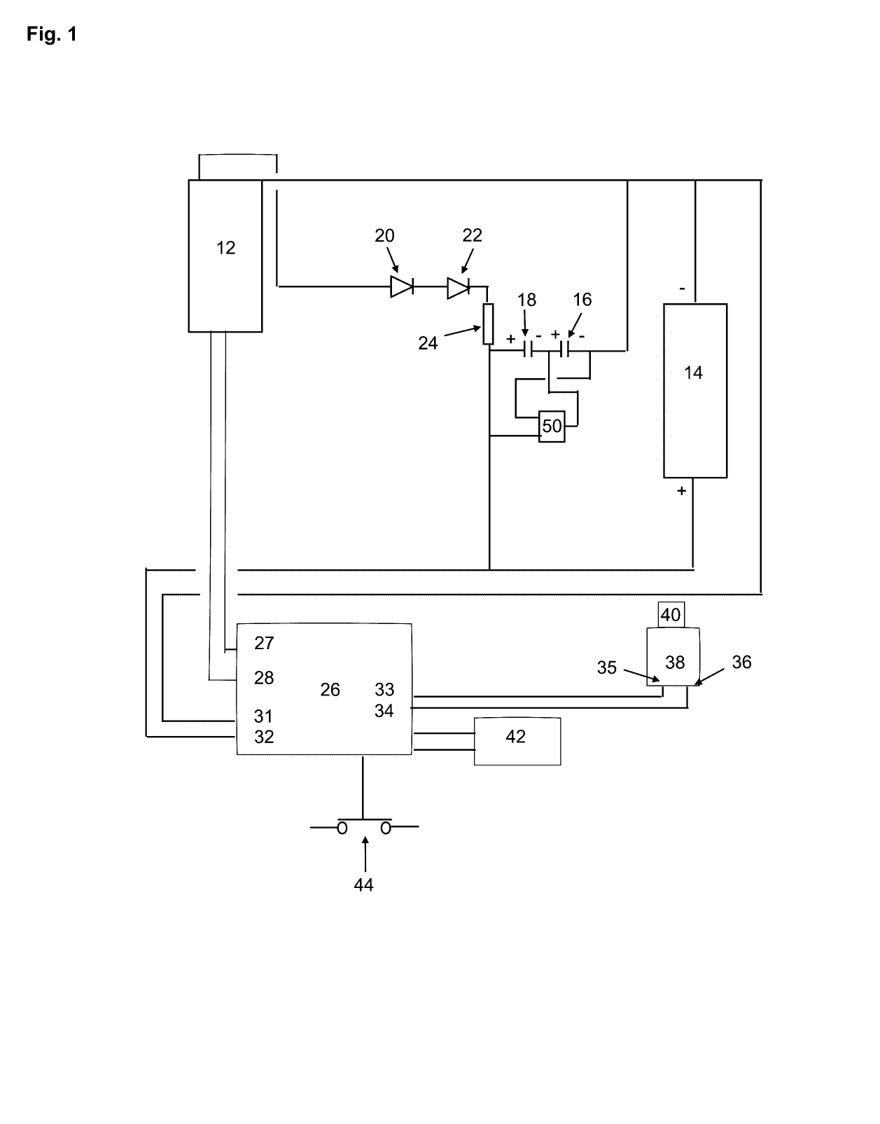

Referring now to the drawings, the super capacitor vaping electronic cigarette is generally designated by the numeral 10. In one embodiment as depicted in FIG. 1, super capacitor vaping electronic cigarette 10 includes charging port 12, which can preferably include a USB charging port having an output terminal (−) operatively connected to an input (−) of battery 14 and an input terminal (−) of super capacitor 16 which in turn has an output terminal (+) operatively connected in series to an input terminal (−) of super capacitor 18 which in turn has an output terminal (+). The USB charging port 12 also has a terminal operatively connected to an output terminal (+) of a diode 20 which in turn has an input terminal (+) operatively connected in series to an output terminal (−) of a diode 22. An input terminal (+) of the second diode 22 operatively connects to an output terminal of resistor 24 and which in turn has input terminal connected to output terminal (+) of second super capacitors 18.

Additionally, there is provided a controller chip (processor) 26 which has a charge terminals 27, 28 operatively connected to charge terminals 29, 30, respectively of USB charger 12. Power terminals 31, 32 of chip 26, operatively connect to input terminal (+) of super capacitor 18 and output terminal (−) of super capacitor 16, respectively. The resistor 24 and diodes 20, 22 slow the draw from USB charging when super capacitors 16, 18 are without any charge or the battery 14 is operative.

Terminals 33, 34 of controller chip 26 operatively connect to terminal 35, 36, respectively, of a coil 38 connected to vaping chamber 40 of the electronic cigarette 10. There can also be provided a display unit 42 operatively connected to controller chip 26.

In an alternative embodiment, there can be provided a Pulse Width Modulation (PWM) controller 43 operatively interposed between the input terminal (+) of battery 14 and the input terminal (+) of first capacitor. In lieu of a control chip 26, a Digital Current Control Board 26′ can be provided which chip 26′ is attached to display screen 42. In this way, there can be provided a readout of battery life, resistance, voltage and wattage as well as a functional vaporizer element.

In both embodiments, the invention is contained by a housing which contain the components in an operable manner to easily access the USB port, display, and chamber for receiving vape material without disassembling the housing.

The controller 26 or digital current control board 26′ is electrically connected to the between the power (super capacitor/battery) 14 and the heating coil 38. A switch 44 or button operably connected to housing 11 and the chip 26/26′ is capable of sending a signal which in turn initiates the heating power of the heating coil 38. The housing 11 includes a removable cover 13 (e.g., threaded) for access to the components therein.

A super capacitor auto balancing (SAB) MOSFET 50 operably interconnected about super capacitor 16 and have a connection between super capacitor 18 and resistor 24 and controller 26 (26′) and power source 14. The SAB) MOSFET 50 is used to keep the super capacitors 16 and 18 in balance while wired in series. This makes super capacitors 16 and 18 safe to use in series do to there inherent voltage leakage.

The invention has of enabling a higher blast of vapor and taste and quickly recharge the device 10. The above described invention is exemplary and the scope of protection of the utility model is not limited to any in the technical scope of the embodiments disclosed. It is contemplated that variations, modifications and alternatives fall within the scope of claims appended hereto.

What is claimed is:

1. A super capacitor vaping electronic cigarette, which includes:
a housing having a charger with a charging port exposed from said housing;
a power source for generating a current;
one or more super capacitor operatively disposed in said housing and operatively connected to receive a current from said power source;
a resistor disposed in said housing and operatively connected to said one or more super capacitor;
one or more diode operatively disposed in said housing and operatively interconnecting said charger and said resistor to receive a current therethrough;
a controller disposed in said housing and operatively connected to said one or more capacitor to receive a current therefrom;
a heating element disposed in said housing and operatively connected to said controller to receive a current therefrom;
a vaping chamber operatively connected to said heating element to receive a vaporizable material therein whereupon so receiving and said heating element receiving current, the material is vaporized; and
a switch operatively connected to the housing and controller for initiating a signal to energize said coil.

2. The super capacitor vaping electronic cigarette of claim 1, which further includes a display operatively connected to said controller.

3. The super capacitor vaping electronic cigarette of claim 1, wherein said power source is a battery disposed in said housing.

4. The super capacitor vaping electronic cigarette of claim 1, wherein said one or more capacitor is characterized to includes a first super capacitor operatively connected in series to a second super capacitor, wherein said first capacitor is operatively connected to said charger, said power source, and said controller and said second super capacitor is operatively connected to said resistor and said controller.

5. The super capacitor vaping electronic cigarette of claim 1, wherein said charger includes a USB charger and charging port.

6. The super capacitor vaping electronic cigarette of claim 1, wherein said one or more diode includes a first diode operatively connected to said resistor and connected in series to a second diode which in turn operatively connects to said charger.

7. The super capacitor vaping electronic cigarette of claim 1, which includes a super capacitor auto balancing MOSFET operably interconnected about said super capacitor and between, resistor, controller and power source.

8. A super capacitor vaping electronic cigarette, which includes:
a housing having a charger with a charging port exposed from said housing;
a power source for generating a current;
a pulse width modulator operatively disposed in said housing operatively connected to said charger and said power source to receive a current therefrom;
one or more super capacitor operatively disposed in said housing and operatively connected to receive a current from said pulse with modulator;
a digital current control board controller disposed in said housing and operatively connected to said one or more capacitor to receive a current therefrom;
a heating element disposed in said housing and operatively connected to said digital current control board controller to receive a current therefrom;
a vaping chamber operatively connected to said heating element to receive a vaporizable material therein whereupon so receiving and said heating element receiving current, the material is vaporized; and
a switch operatively connected to the housing and controller for initiating a signal to energize said coil.

9. The super capacitor vaping electronic cigarette of claim 8, which further includes a display operatively connected to said digital current control board controller.

10. The super capacitor vaping electronic cigarette of claim 8, wherein said power source is a battery disposed in said housing.

11. The super capacitor vaping electronic cigarette of claim 8, wherein said one or more capacitor is characterized to includes a first super capacitor operatively connected in series to a second super capacitor, wherein said first super capacitor is operatively connected to said pulse width modulator and said digital current control board controller and said second super capacitor is operatively connected to said first super capacitor and said digital current control board controller.

12. The super capacitor vaping electronic cigarette of claim 8, wherein said charger includes a USB charger and charging port.

13. The super capacitor vaping electronic cigarette of claim 8, which includes a super capacitor auto balancing MOSFET operably interconnected about said super capacitor and between, resistor, controller and power source.
